(19) United States
(12) Patent Application Publication
(10) Pub. No.: US 2024/0084826 A1
(43) Pub. Date: Mar. 14, 2024

(54) MULTILAYERED COMPOSITE FLUIDIC FIBER ACTUATOR, A METHOD OF PRODUCING SUCH AND A FLUIDIC ACTUATOR CONTROL AND MEASUREMENT SYSTEM

(71) Applicants: Ózgun Kilic Afsar, Boston, MA (US); Klas Anders Hjort, Uppsala (SE)

(72) Inventors: Özgun KILIC AFSAR, Boston, MA (US); Klas Anders Hjort, Uppsala (SE); Seung Hee JEONG, Uppsala (SE)

(21) Appl. No.: 17/944,669

(22) Filed: Sep. 14, 2022

(51) Int. Cl. F15B 15/28; F15B 15/10

(52) U.S. Cl. CPC F15B 15/2815; F15B 15/103; F15B 2215/305

(57) ABSTRACT

The present invention relates to a multilayered composite fluidic fiber actuator, to a method of producing such and to a fluidic actuator control and measurement system comprising a multilayered composite fluidic fiber actuator comprising an elongated elastic tube. The multilayered composite fluidic fiber actuator comprises at least o first and a second stretchable resistive sensor provided on the outer surface of and integrated with the elongated elastic tube and is enclosed by an interlocked sleeve. At least a first portion in the longitudinal direction of the elongated elastic tube has a first configuration and a second portion in the longitudinal direction of the elongated elastic tube has a second and different configuration of the first stretchable resistive sensor and the second stretchable resistive sensor.

### TECHNICAL FIELD

The present invention relates to a multilayered composite fluidic fiber actuator, to a method of producing such and to a fluidic actuator control and measurement system comprising a multilayered composite fluidic fiber actuator.

### BACKGROUND

In recent years, there have been remarkable advancements in material science and engineering that yield a plethora of advanced engineered fibers that combine multiple functionalities in a single package. These fibers can morph in response to external stimuli such as heat, light, magnetic or electric fields, chemicals, fluid pressure, etc. Morphing textiles made of such fibers have been envisioned as a soft, body compliant, and clothing-like alternative to exoskeletons used in assisting motor tasks.

However, limitations in reversibility, low actuation strokes (scaling with the amount of storable strain in the fiber), high actuation temperatures that risk harming the human skin, slow response times, bulkiness and limited scalability of existing solutions have hindered the full realization of morphing textiles. Common morphing materials that have been integrated into textiles include pneumatic bladders, tendon-based actuators, shape memory alloys and polymers, dielectric elastomer actuators, and liquid crystal elastomers. Each approach has non-ideal qualities for seamless active textiles. Fluidic actuation requires a bulky source of air and control module, or an irreversible chemical reaction. Electrical actuation requires a battery or other electrical source. Thermal actuation is often relatively slow, with actuation times around one minute, and may present safety concerns for use in garments such as risk of burning the human skin.

On the other hand, some fluid actuated systems allow for large storable strains necessary to achieve high levels of compression required for some medical, industrial, and space exploration applications. Somewhat simplified, fluidic actuators may be seen as belonging to one of two main classes: Bulky Fluidic “Textile” Actuators and Thin Fluidic Actuators.

The class of Bulky Fluidic Actuators that constitute the dominant percentage of existing pneumatic artificial muscles (PAMs) in wearable applications are embodied in textile forms, rather than fiber form. These existing actuators employ a surrounding textile structure to constrain the expansion of a stretchable bladder, causing the composite actuator to expand radially and contract along the axial direction when pressurized. Still, due to the complex topographies that can be achieved in these actuators, they have been favorable compared to the thermo-responsive or electroactive counterparts which are limited to basic axial and torsional motions.

Unlike fluidic actuators discussed in the previous section, thin fluidic actuators such as fluidic active yarn actuators employ fluidic tubular bodies that resemble a fiber or yarn, which are then structured into textiles to program higher hierarchical levels of actuation. Researchers have explored “braided pneumatic yarns” to increase the axial contraction ratio, however one issue in this approach is that the braids of different yarns may potentially interfere with each other through frictional effects or “jamming” during operation. In these works, only simple axial motions with these actuators have been explored with diameters larger than 2.5 mm. The air source and control module remain large and bulky, hindering dissemination into mobile and dynamic wearable applications. Furthermore, the textile integration elements for wearable robotic interfaces; namely sensors, actuators, power, and control elements have not yet been implemented to support seamless integration. A comprehensive review is given in “Textile Technology for Soft Robotic and Autonomous Garments”, Vanessa Sanchez et al., Adv. Funct. Mater. 2020, 2008278.

US2018252244 discloses a McKibben type artificial muscle that comprises a braided sleeve with varying properties along the length of the fiber.

U.S. Pat. No. 9,541,196B2 discloses a hydraulic actuator including a tubular bladder. The hydraulic actuator is flexible and has an overall diameter less than 5 mm. The actuator may be provided with strain and/or pressure sensors. The nature of these sensors and their interaction with the actuator is not described.

In the scientific report “Contraction Sensing With Smart Braid McKibben Muscles, Wyatt Felt et al, IEEE/ASME TRANSACTIONS ON MECHATRONICS, VOL. 21, NO. 3, JUNE 2016 discloses a McKibben type artificial muscle or muscle that comprises one or more strain sensors incorporated in the braided sleeve—referred to as the “Smart Braid”. This setup provides for a closed-loop control of generated motions.

In the scientific report “A contraction length feedback method for the McKibben pneumatic artificial muscle” by Songyi ZhongZiyi et al, Sensors and Actuators A: Physical Volume 334, 1 Feb. 2022, 113321, sensors that register changes in the diameter of the actuator is utilized to provide feedback to a control system.

Prior art fluid actuators of McKibben type that are suitable for system providing motion sensing and real time actuation control, are either relatively thick if utilizing internal sensors and therefore not suitable to be incorporated in fabric or other wearable devices. Alternatively, thin fluid actuators are utilized in combination with additional hardware providing the sensing function, the combination having the same drawbacks as the thick fluid actuators.

### SUMMARY

The object of the present invention is to overcome the drawbacks associated with prior art fluid actuators. This is achieved by the multilayered composite fluidic fiber actuator as defined by claim 1, the fluidic actuator control and measurement system as defined by claim 20, the artificial muscle as defined by claim 23, the fabric as defined by claim 24 and by the method of producing a multilayered composite fluidic fiber actuator as defined by claim 26.

According to one aspect of the invention a multilayered composite fluidic fiber actuator arranged to have at least a first and a second morphing state dependent on the pressure of an internal fluid is provided. The multilayered composite fluidic fiber actuator comprises:
an elongated elastic tube with a hollow body, the hollow body arranged to accommodate the internal fluid, the elongated elastic tube having a first end, and a second end and at least at one of the first and a second end is provided with fluid connector;
an interlocked sleeve enclosing the elongated elastic tube and extending a major portion of the elongated elastic tube in the longitudinal direction;
a first stretchable resistive sensor provided on the outer surface of and integrated with the elongated elastic tube and enclosed by the interlocked sleeve and extending a first distance on the elongated elastic tube, the first stretchable resistive sensor comprising connecting means and
at least a second stretchable resistive sensor provided on the outer surface of and integrated with the elongated elastic tube and enclosed by the interlocked sleeve and extending a second distance on the elongated elastic tube, the second stretchable resistive sensor comprising connecting means; and wherein the second stretchable resistive sensor is electrically separated from the first stretchable resistive sensor, and wherein at least a first portion in the longitudinal direction of the elongated elastic tube has a first configuration and a second portion in the longitudinal direction of the elongated elastic tube has a second and different configuration of the first stretchable resistive sensor and the second stretchable resistive sensor.

According to one embodiment of the invention the first stretchable resistive sensor is elongated and extends a first distance in the longitudinal direction of the elongated elastic tube and thereby arranged to register the strain in the longitudinal direction, and
the second stretchable resistive sensor is elongated and extends a second distance in the longitudinal direction of the elongated elastic tube and thereby arranged to register the strain in the longitudinal direction, and wherein the first and second stretchable resistive sensors are arranged so that for a portion in the longitudinal direction of the elongated elastic tube only one of the first and second stretchable resistive sensors is present.

According to one embodiment of the invention the first stretchable resistive sensor extends a first portion in the longitudinal direction of the elongated elastic tube and the second stretchable resistive sensor extends a second portion in the longitudinal direction of the elongated elastic tube and wherein the first portion and the second portion are separated and sequential in the longitudinal direction of the elongated elastic tube.

According to one embodiment of the invention the multilayered composite fluidic fiber actuator further comprises:
a third stretchable resistive sensor provided on the outer surface of and integrated with the elongated elastic tube and enclosed by the interlocked sleeve and extending a third distance in the longitudinal direction of the elongated elastic tube, the third stretchable resistive sensor comprising connecting means, the third stretchable resistive sensor at least partly overlapping in the longitudinal direction with the first stretchable resistive sensor and wherein the first stretchable resistive sensor is provided on a first half, A, and the third stretchable resistive sensor is provided on the opposite half, B, of the elongated elastic tube in a cross-sectional view of the elongated elastic tube, the first stretchable resistive sensor and the third stretchable resistive sensor forming a first sensor pair; and
a fourth stretchable resistive sensor provided on the outer surface of and integrated with the elongated elastic tube and enclosed by the interlocked sleeve and extending a fourth distance in the longitudinal direction of the elongated elastic tube, the fourth stretchable resistive sensor comprising connecting means, the fourth stretchable resistive sensor at least partly overlapping in the longitudinal direction with the second stretchable resistive sensor and wherein the second stretchable resistive sensor is provided on a third half, C, and the fourth stretchable resistive sensor is provided on the opposite half, D, of the elongated elastic tube in a cross-sectional view of the elongated elastic tube, the second stretchable resistive sensor and the fourth stretchable resistive sensor forming a second sensor pair.

According to one embodiment of the invention the first stretchable resistive sensor and the third stretchable resistive sensor are arranged essentially opposite each other in the cross-sectional view of the elongated elastic tube and/or the second stretchable resistive sensor and the fourth stretchable resistive sensor are arranged essentially opposite each other in the cross-sectional view of the elongated elastic tube.

According to one embodiment of the invention the first stretchable resistive sensor and the second stretchable resistive sensor are positioned sequentially in the longitudinal direction of the elongated elastic tube and having the same circumferential position in the cross-sectional view of the elongated elastic tube; and/or the third stretchable resistive sensor and the fourth stretchable resistive sensor are positioned sequentially in the longitudinal direction of the elongated elastic tube and having the same circumferential position in the cross sectional view of the elongated elastic tube.

According to one embodiment of the invention the multilayered composite fluidic fiber actuator further comprises:
at least three stretchable resistive sensor are provided in the first longitudinal portion of the elongated elastic tube and evenly distributed on the circumference of the elongated elastic tube; and
at least three stretchable resistive sensor provided in the second longitudinal portion of the elongated elastic tube and evenly distributed on the circumference of the elongated elastic tube, thereby providing a capability of 3D information of the motion and/or morphing state of the of the multilayered composite fluidic fiber actuator.

According to one embodiment of the invention the at least one of the stretchable resistive sensors comprises a first thin sensor leg extending in the longitudinal direction of the elongated elastic tube, and a thin second leg extending in the same longitudinal direction of the elongated elastic tube and wherein the first and second leg are electrically joined at their distal ends.

According to one embodiment of the invention:
the first stretchable resistive sensor comprises a first thin sensor leg extending from the first end towards the second end of the elongated elastic tube, and a thin second leg extending from the first end towards the second end of the elongated elastic tube and wherein the first and second leg are electrically joined at their distal ends; and wherein
the third stretchable resistive sensor comprises a first thin sensor leg extending from the first end towards the second end of the elongated elastic tube, and a thin second leg extending from the first end towards the second end of the elongated elastic tube and wherein the first and second leg are electrically joined at their distal ends; and wherein
the second stretchable resistive sensor comprises a first thin sensor leg extending from the second end towards the first end of the elongated elastic tube, and a thin second leg extending from the second end towards the first end of the elongated elastic tube and wherein the first and second leg are electrically joined at their distal ends and wherein
the fourth stretchable resistive sensor comprises a first thin sensor leg extending from the second end towards the first end of the elongated elastic tube, and a thin second leg extending from the second end towards the first end of the elongated elastic tube and wherein the first and second leg are electrically joined at their distal ends.

According to one embodiment of the invention at least one of stretchable resistive sensors is arranged as a continuous thin structure and the first and second legs are joined by a U-shaped portion at their distal end.

According to one embodiment of the invention at least one of the first stretchable resistive sensor and the second stretchable resistive sensor is spiraled around the elongated elastic tube.

According to one embodiment of the invention:
the first stretchable resistive sensor extends a first distance primarily in the transversal direction of the elongated elastic tube and thereby arranged to register strain relating to a radial expansion of the elongated elastic tube at the first portion of the elongated elastic tube, and
the second stretchable resistive sensor extends a second distance primarily in the transversal direction of the elongated elastic tube and thereby arranged to register strain relating to a radial expansion of the elongated elastic tube at the second portion of the elongated elastic tube; and wherein the first and second stretchable resistive sensors are provided in separate longitudinal portions of the elongated elastic tube.

According to embodiments of the invention the stretchable resistive sensor is formed from a material comprising electrically conducting particles, for example but not limited to an elastomer material comprising electrically conducting nanoparticles such as carbon black. Alternatively, the stretchable resistive sensor is formed from a material comprising liquid metal particles or droplets.

According to one embodiment of the invention the stretchable resistive sensor is a deposited structure on the elongated elastic tube. The stretchable resistive sensor may have been deposited by spraying or printing in a way that the stretchable resistive sensor becomes an integrated part of the elongated elastic tube.

According to one embodiment of the invention the elongated elastic tube has an average diameter in its non-pressurized state that is less than 3 mm, preferably less than 2 mm and even more preferably less than 1 mm and each individual stretchable resistive sensor or thin sensor leg in the circumferential direction extends in the range 0.1-2 mm, preferably in the range 0.25-1 mm.

According to one embodiment of the invention the interlocked sleeve has a varying configuration along the length of the multilayered composite fluidic fiber actuator, thereby providing varying morphing properties along the length of the multilayered composite fluidic fiber actuator, the varying configuration comprising a variation in one or a combination of: number of filaments, angles between the filaments, thickness of the filaments, and added constraints.

According to one aspect of the invention a fluidic actuator control and measurement system is provided. The fluidic actuator control and measurement system comprises:
a plurality of multilayered composite fluidic fiber actuators according to above;
a pressure fluid source arranged to be in individual fluidic communication with the fluid connectors of the multilayered composite fluidic fiber actuators;
a sensor connection module arranged to be in individual electrical communication with the sensors of the multilayered composite fluidic fiber actuators; and
a control unit arranged to communicate with the pump module and the sensor connection module, and wherein the control unit is arranged to receive resistive data for at least a portion of the individual sensors of the individual multilayered composite fluidic fiber actuators and to control the pump module to apply fluid pressure to at least a portion of the individual multilayered composite fluidic fiber actuators.

According to one embodiment of the invention each multilayered composite fluidic fiber actuator comprises at least four sensors in a pairwise configuration and the sensor connection module is provided with a 4-channel input for each multilayered composite fluidic fiber actuator.

According to one embodiment of the invention the fluidic actuator control and measurement system is arranged to operate at frequencies up to 40 Hz.

According to one aspect of the invention an artificial muscle comprising a plurality of multilayered composite fluidic fiber actuators is provided.

According to one aspect of the invention a fabric, being woven or knitted, comprising a plurality of multilayered composite fluidic fiber actuators is provided. The multilayered composite fluidic fiber actuators may be provided in the fabric in one or a combination of the forms:
a 1D structure such as a yarn or sewn into the fabric as single strands; or 2-, 4-, 8-ply yarns
a 2D knitted structure such as a jersey knit, an interlock knit, a rib knit, a horizontal inlay, a vertical inlay, a diagonal inlay, a bourlette knit, a tubular knit, a pleated knit using wale direction, a pleated knit using course direction, intarsia, floating structures and fabric with protruding ridges;
a 2D woven structure such as a single-layer weave, twill weave, double woven, deflected double woven, or block weave structure;
a 3D structure such as a 3D knitted spacer fabric with active yarn spacers, a 3D knitted spacer fabric with active knitted walls, or multi-tube circular knitted fabrics.

According to one aspect of the invention a method of producing a multilayered composite fluidic fiber actuator is provided. The produced multilayered composite fluidic fiber actuator comprises an elongated elastic tube with a hollow body, an interlocked sleeve enclosing the elongated elastic tube and extending a major portion of the elongated elastic tube in the longitudinal direction and at least one stretchable resistive sensor.

The method comprises the steps of:
providing an elongated elastic tube;
providing a sprayable liquid conducting medium;
providing a stencil mask on the elongated elastic tube, the mask provided with at least one elongated opening, the elongated opening defining the stretchable resistive sensor 130;
spraying the liquid conducting medium onto the elongated elastic tube partly covered by the stencil mask;
removing the stencil mask;
consolidating the liquid conducting medium to form a stretchable conducting elastomer forming the stretchable resistive sensor; and
applying an interlocked sleeve on the elongated elastic tube covering the stretchable resistive sensor.

According to one embodiment of the invention the method comprises the further step of applying a protective layer onto the elongated elastic tube and the stretchable resistive sensor prior to the step of applying the interlocked sleeve.

According to embodiments of the invention the liquid conducting medium is selected from the list: carbon-based powders in solvent, carbon powders and elastomer in solvent, liquid metal particles, liquid metal particles in solvent. Depending on the selection of the liquid conducting medium
the consolidating step may include curing the sprayed liquid conducting medium.

Thanks to the invention the multilayered composite fluidic fiber actuator may be fabricated in long lengths and due to its thinness and flexibility and that the stretchable resistive sensors are integrated with the elongated elastic tube can be handled like a yarn or textile fiber.

One advantage afforded by the multilayered composite fluidic fiber actuator according to the invention is that 2D information may be extracted from resistivity measurements of the at least four individual stretchable resistive sensors, making it possible to detect and control for example an S-shape morphing state.

A further advantage of the present invention relates to the small volumes of fluid required for the actuation of the multilayered composite fluidic fiber actuators in a system utilizing a plurality of such. The small volume of the interior of elongated elastic tube in combination with the flexibility of the multilayered composite fluidic fiber actuators and the system components described above makes the fluidic actuator control and measurement system particularly suitable for high frequency operations—in this case meaning operating at frequencies up to 40 Hz. Thereby the fluidic actuator control and measurement system can provide a vibrational sensing system and/or vibrational system for applying vibrations to a user.

Many additional benefits and advantages of the present invention will be readily understood by the skilled person in view of the detailed description below and accompanying drawings.

### DRAWINGS

The invention will now be described in more detail with reference to the appended drawings.

FIGS. 1a-h schematically illustrate embodiments of the present invention.

FIGS. 2a-c schematically illustrate different alternatives of the interlocked sleeve utilized in the present invention.

FIGS. 3a-b schematically illustrate different morphing states that can be measured and controlled by the present invention.

FIG. 4 schematically illustrates a spool comprising the multilayered composite fluidic fiber actuator according to the invention.

FIG. 5 schematically illustrates the fluidic actuator control and measurement system according to the invention.

FIG. 6 is a flowchart illustrating the method according to the invention.

FIG. 7a-b schematically illustrate a mask assembly utilized in the method according to the invention.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

Terms such as “top”, “bottom”, upper“, lower”, “below”, “above” etc are used merely with reference to the geometry of the embodiment of the invention shown in the drawings and/or during normal operation or mounting of the device/devices and are not intended to limit the invention in any manner.

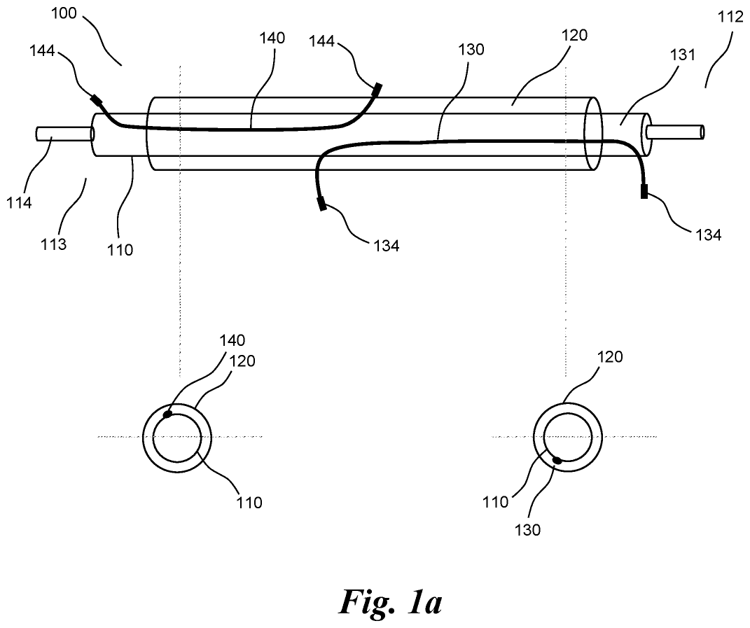

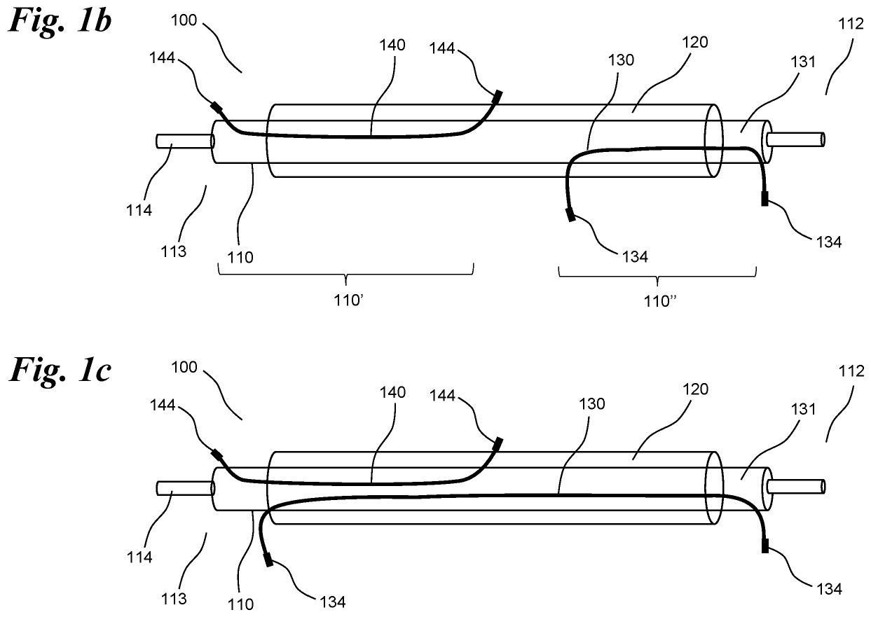

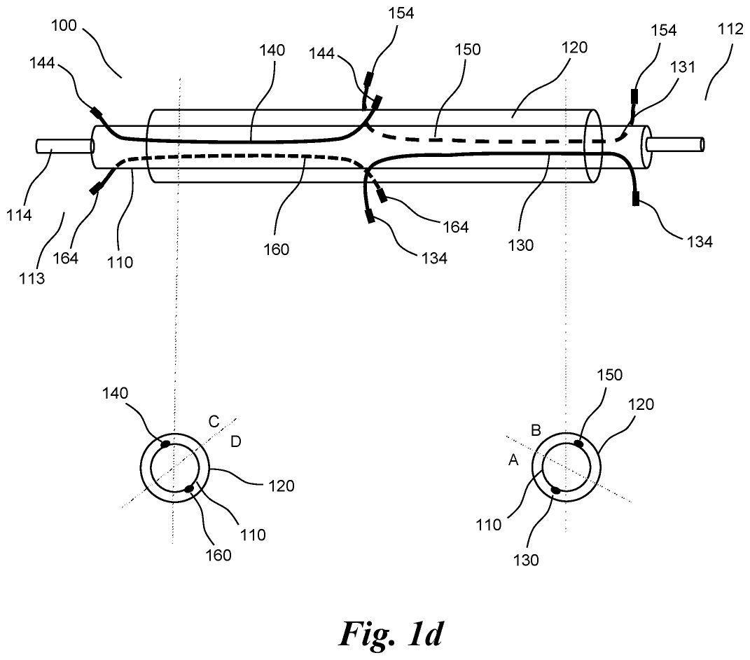

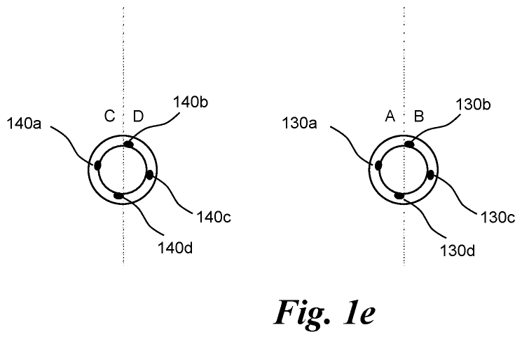

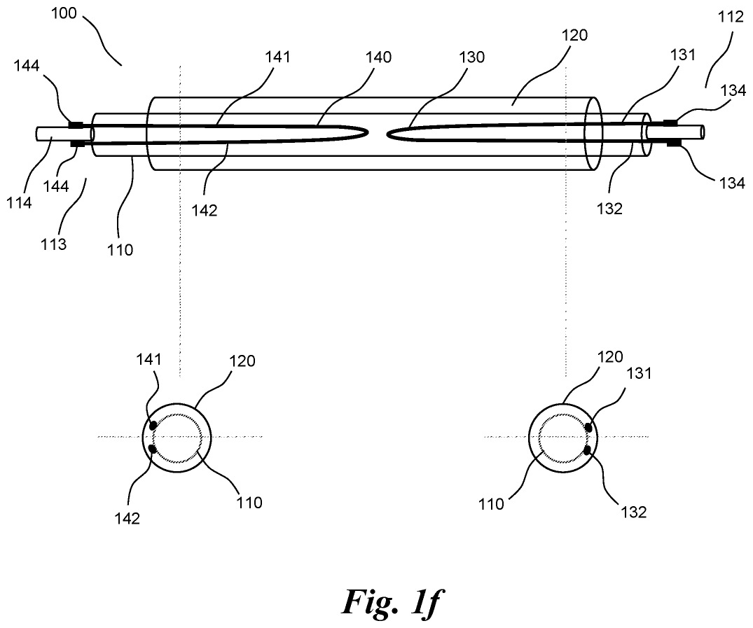

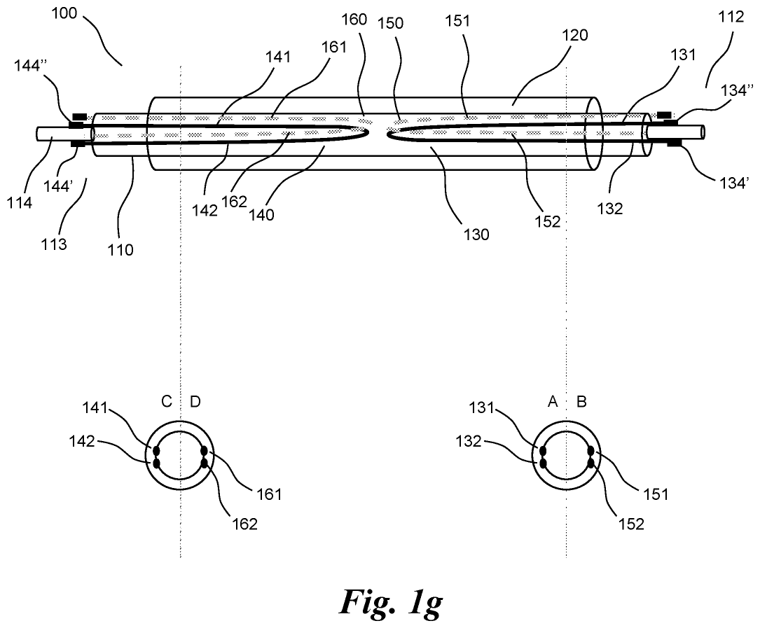

Embodiments of the multilayered composite fluidic fiber actuator according to the invention are schematically illustrated in FIGS. 1a-h. The multilayered composite fluidic fiber actuator 100 comprises an elongated elastic tube 110 with a hollow body 111. The hollow body 111 is arranged to during use accommodate an internal fluid (not shown). The multilayered composite fluidic fiber actuator 100 is arranged to have at least a first and a second morphing state dependent on the pressure of the internal fluid. The internal fluid may be in a liquid or gaseous state and the term fluid does herein encompass both states. The elongated elastic tube 110 has a first end 112 and a second end 113 and at least at one of the first 112 and a second end 113 is provided with fluid connector 114 which during use is in fluid communication with pressurizing means, for example a micro pump or similar device. The elongated elastic tube is enclosed by an interlocked sleeve 120, for example a braided sleeve that extends a major portion of the elongated elastic tube 110 in the longitudinal direction. Typically, all of the elongated elastic tube 110 except the fluid connector/connectors is enclosed by the interlocked sleeve 120. The interlocked sleeve 120 typically has longitudinal variations in its constriction properties giving the different morphing states. Interlocked sleeve materials and designs and in particular braided sleeves will be further discussed below.

The multilayered composite fluidic fiber actuator 100 according to the invention is provided with at least a first stretchable resistive sensor 130 and a second stretchable resistive sensor 140. The first and second stretchable resistive sensors 130/140 are provided on the outer surface of the elongated elastic tube 110 and integrated with the elongated elastic tube 110 so that the stretchable sensors follow the motions of the elongated elastic tube 110. The stretchable resistive sensors may typically be deposited on the elongated elastic tube 110 by for example spraying, which will be further discussed below. The first stretchable resistive sensor 130 and the second stretchable resistive sensor 140, being integrated with the elongated elastic tube 110 are consequently also enclosed by the interlocked sleeve 120. The first and second stretchable resistive sensors 130/140 are provided with individual connecting means connecting means 134, 144 and are electrically separated from each other so that individual resistive signals may be received from respective sensor. The first stretchable resistive sensor 130 is provided at a first position and extends a first distance on the elongated elastic tube 110. The second stretchable resistive sensor 140 is provided at a second position and extends a second distance on the elongated elastic tube 110. The first and second stretchable resistive sensors 130/140 are positioned and extends so that least a first portion in the longitudinal direction of the elongated elastic tube 110 has a first configuration and a second portion in the longitudinal direction of the elongated elastic tube 110 has a second and different configuration of the stretchable resistive sensors 130/140. Thereby it will be possible to discern between a first resistive signal relating to the first portion of the elongated elastic tube 110 and a corresponding first portion of the multilayered composite fluidic fiber actuator 100 and second resistive signal relating to the second portion of the elongated elastic tube 110 and a corresponding second portion of the multilayered composite fluidic fiber actuator 100. The first and second stretchable resistive sensors 130/140 may be referred to as localized sensors providing localized measures of the strain in the longitudinal direction of the multilayered composite fluidic fiber actuator 100.

According to one embodiment schematically illustrated in FIG. 1a, wherein the upper part is a sideview, and the lower part two different cross-section of the multilayered composite fluidic fiber actuator 100, the first and second stretchable resistive sensors 130/140 are elongated in the longitudinal direction of the elongated elastic tube 110 and thereby arranged to register strains in the longitudinal direction. The first stretchable resistive sensor 130 is arranged at a first position and extends a first distance in the longitudinal direction of the elongated elastic tube 110. The second stretchable resistive sensor 140 is arranged at a second position and extends a second distance in the longitudinal direction of the elongated elastic tube 110. The first and second stretchable resistive sensors 130/140 are arranged so that for a portion in the longitudinal direction of the elongated elastic tube 110 only one of the first and second stretchable resistive sensors 130/140 is present.

According to one embodiment of the multilayered composite fluidic fiber actuator 100, schematically illustrated in FIG. 1b, the first stretchable resistive sensor 130 extends over a first portion 110′ in the longitudinal direction of the elongated elastic tube 110 and the second stretchable resistive sensor 140 extends over a second portion 110″ in the longitudinal direction of the elongated elastic tube 110. and the wherein the first portion 110′ and the second portion 110″ are separated and sequential in the longitudinal direction of the elongated elastic tube 110. Thereby, there is no overlap in the longitudinal direction of the first stretchable resistive sensor 130 and the second stretchable resistive sensor 140. This simplifies the interpretation of the measured resistivity of the first stretchable resistive sensor 130 and the second stretchable resistive sensor 140 during use.

Alternatively, as schematically illustrated in FIG. 1c, first stretchable resistive sensor 130 and the second stretchable resistive sensor 140 are arranged as partly overlapping in the longitudinal direction of the elongated elastic tube 110. Localized strain information may still be possible to extract by for example compensating the measured resistive signal relating to the first stretchable resistive sensor 130 with the measured resistive signal relating to the second stretchable resistive sensor 140.

According to one embodiment of the multilayered composite fluidic fiber actuator 100, schematically illustrated in FIG. 1d, wherein the upper part is a sideview, partly “see-through”, and the lower part two different cross-section of the multilayered composite fluidic fiber actuator 100, a third stretchable resistive sensor 150 and a fourth stretchable resistive sensor 160 are provided. The third stretchable resistive sensor 150 is arranged on a third position on the outer surface of and integrated with the elongated elastic tube 110, is enclosed by the interlocked sleeve 120 and extends a third distance in the longitudinal direction. The third stretchable resistive sensor 150 comprising connecting means 154. The third stretchable resistive sensor 150 is in the longitudinal direction at least partly overlapping with the first stretchable resistive sensor 130. The first stretchable resistive sensor 130 is provided on a first half A and the third stretchable resistive sensor 150 are provided on the opposite half B of the elongated elastic tube 110 in a cross-sectional view. The first stretchable resistive sensor 130 and the third stretchable resistive sensor 150 forms a first sensor pair 139, which during use can provide localized strain information in 2D relating to the first portion of the multilayered composite fluidic fiber actuator 100, for example bending of the multilayered composite fluidic fiber actuator 100 in one direction and bending in an opposite direction. The fourth stretchable resistive sensor 160 is arranged at a fourth position provided on the outer surface of and integrated with the elongated elastic tube 110, is enclosed by the interlocked sleeve 120 and extends a fourth distance in the longitudinal direction of the elongated elastic tube 110. The fourth stretchable resistive sensor 160 comprises connecting means 164. The fourth stretchable resistive sensor 160 is arranged to at least partly overlap in the longitudinal direction with the second stretchable resistive sensor 140. The second stretchable resistive sensor 140 is provided on a third half C and the fourth stretchable resistive sensor 160 is provided on the opposite half D of the elongated elastic tube 110 in the cross-sectional view The second stretchable resistive sensor 140 and the fourth stretchable resistive sensor 160 forms a second sensor pair 149, which during use can provide localized strain information in 2D relating to the second portion of the multilayered composite fluidic fiber actuator 100.

According to one embodiment of the multilayered composite fluidic fiber actuator 100, the first stretchable resistive sensor 130 and the third stretchable resistive sensor 150 are arranged essentially opposite each other in the cross-sectional view of the elongated elastic tube 110 and/or the second stretchable resistive sensor 140 and the fourth stretchable resistive sensor 160 are arranged essentially opposite each other in the cross-sectional view of the elongated elastic tube 110. The first stretchable resistive sensor 130 and the second stretchable resistive sensor 140 may be positioned sequentially in the longitudinal direction of the elongated elastic tube 110 and with the same circumferential position in the cross-sectional view of the elongated elastic tube 110. In the same manner may the third stretchable resistive sensor 150 and the fourth stretchable resistive sensor 160 are positioned sequentially in the longitudinal direction of the elongated elastic tube 110 and with the same circumferential position in the cross-sectional view of the elongated elastic tube 110. These arrangements simplify the interpretation of the resistive signals from the sensors.

According to one embodiment of the multilayered composite fluidic fiber actuator 100, schematically illustrated in a cross-sectional view in FIG. 1e, three or more stretchable resistive sensor 130a-d are provided in the first longitudinal portion of the elongated elastic tube 110, preferably evenly distributed on the circumference of the elongated elastic tube 110. In the same manner three or more stretchable resistive sensor 140a-d are provided in the second longitudinal portion of the elongated elastic tube 110. This arrangement gives a capability of 3D information of the motion and/or morphing state of the of the multilayered composite fluidic fiber actuator 100. According to embodiments of the invention more stretchable resistive sensor may be distributed around the elongated elastic tube 110 for even more information on the mechanical motion and/or morphing state.

According to one embodiment of the multilayered composite fluidic fiber actuator 100 at least one of the stretchable resistive sensors 130/140 is formed with a first thin sensor leg 131/141 and a thin second leg 132/142 typically running in parallel on the surface of the elongated elastic tube 110 as schematically illustrated in FIG. 1f, wherein the upper part is a sideview and the lower part two different cross-section of the multilayered composite fluidic fiber actuator 100. The first thin sensor leg 131/141 extends in the longitudinal direction of the elongated elastic tube and a thin second leg 132/142 extends in the same longitudinal direction of the elongated elastic tube and the first and second leg are electrically joined at their distal ends. As depicted in Figure if the stretchable resistive sensors may be arranged as continuous thin structures and the first and second legs being joined by a U-shaped portion at their distal end. Alternatively, the legs may be joined by other means, for example a separate member of a conducting material connecting the ends of the legs. In the lower part of Figure if the first stretchable resistive sensor 130 and the second stretchable resistive sensor 140 are depicted as positioned on opposite sides of the elongated elastic tube 110. This represents one embodiment of the invention. Also other relative positions in the cross-sectional view may be utilized.

According to one embodiment schematically illustrated in FIG. 1g, wherein the upper part is a sideview, partly “see-through”, and the lower part two different cross-section of the multilayered composite fluidic fiber actuator 100, the first stretchable resistive sensor 130 comprises a first thin sensor leg 131 extending from the first end 112 towards the second end 113 of the elongated elastic tube 110, and a thin second leg 132 extending from the first end 112 towards the second end 113 of the elongated elastic tube 110. The first 131 and second leg 132 are electrically joined at their distal ends. The third stretchable resistive sensor 150 comprises a first thin sensor leg 151 extending from the first end 112 towards the second end 113 of the elongated elastic tube 110, and a thin second leg 152 extending from the first end 112 towards the second end 113 of the elongated elastic tube 110 and the first 151 and second leg 152 are electrically joined at their distal ends. The second stretchable resistive sensor 140 comprises a first thin sensor leg 141 extending from the second end 113 towards the first end 112 of the elongated elastic tube 110, and a thin second leg 142 extending from the second end 113 towards the first end 112 of the elongated elastic tube 110 and the first 141 and second leg 142 are electrically joined at their distal ends. The fourth stretchable resistive sensor 160 comprises a first thin sensor leg 161 extending from the second end 113 towards the first end 112 of the elongated elastic tube 110, and a thin second leg 161 extending from the second end 113 towards the first end 112 of the elongated elastic tube 110 and the first 161 and second leg 162 are electrically joined at their distal ends 133.

As depicted in FIG. 1g, the stretchable resistive sensors may be arranged as continuous thin structures and the first and second legs being joined by a U-shaped portion at their distal end. Alternatively, the legs may be joined by other means, for example a separate member of a conducting material connecting the ends of the legs.

The stretchable resistive sensors may extend in the longitudinal direction along the elongated elastic tube 110 in an essentially straight line. However, it could in certain implementations be advantageous to increase the length, and thereby the total resistance, of a stretchable resistive sensor. Such an increase in length could be made by arranging the stretchable resistive sensor in a waveform, a meander-shape or the like. Another alternative would be to let the stretchable resistive sensor be spiraled around the elongated elastic tube 110.

According to one embodiment of the multilayered composite fluidic fiber actuator 100, schematically illustrated in FIG. 1h, wherein the upper part is a sideview, partly “see-through”, and the lower part two different cross-section of the multilayered composite fluidic fiber actuator 100, a stretchable resistive sensor may extend primarily in transversal direction of the elongated elastic tube 110. According to the embodiment the first stretchable resistive sensor 130′ is positioned in a first longitudinal portion and extends a first distance primarily in the transversal direction of the elongated elastic tube 110 and is thereby arranged to register strain relating to a radial expansion of the elongated elastic tube 110 at the first portion of the elongated elastic tube 110. The second stretchable resistive sensor 140′ is positioned in a second longitudinal portion and extends a second distance primarily in the transversal direction of the elongated elastic tube 110 and is thereby arranged to register strain relating to a radial expansion of the elongated elastic tube 110 at the second portion of the elongated elastic tube 110. As seen in the cross-sectional views, the first and the second stretchable resistive sensors 130′, 140″ follows the circumference of the elongated elastic tube 110 and forms a circle sector. The first and the second stretchable resistive sensors 130′, 140′ may be arranged to form almost a full circle.

As apparent for the skilled person the different variations and embodiments described above with reference to stretchable resistive sensors extended in the longitudinal directions are relevant also to the transversally extending stretchable resistive sensors.

According to embodiments of the invention the elongated elastic tube 110 has an average diameter in its non-pressurized state that is less than 3 mm, preferably less than 2 mm and even more preferably less than 1.6 mm. The individual stretchable resistive sensor or thin sensor leg needs, due to manufacturing factors and in order to keep the resistivity in a useful range, have a thickness in the range of 0.001-0.1 mm and a width in the range of 0.1-2 mm, preferably in the range of 0.25-1.00 mm. The height of the stretchable resistive sensor is typically in the order of a few microns. Hence, the individual stretchable resistive sensor or thin sensor leg 142 should extend, in the circumferential direction, in the range of 15-60% of the diameter of the elongated elastic tube 110 in its relaxed state.

The stretchable resistive sensors in the multilayered composite fluidic fiber actuator 100 according to the invention comprises conducting particles of a size in the micro- or nanometer range. The conducting particles are arranged to form an electrically percolating network on the surface of the elongated elastic tube 110. Particles should be interpreted in a broad meaning encompassing highly conducting particles and powders, such as, but not limited to carbon black nanoparticles, graphene nanoparticles, carbon nanotubes, and metal nanoparticles. Particles should be interpreted as a powder with particle sizes primarily in the nanometer and micrometer range, not excluding that the powder may comprise larger particles. A suitable and commercially available carbon black particles is Ketjenblack EC-300J from HM ROYAL. According to one embodiment the conducting particles are electrically conducting nanoparticles.

According to one embodiment the stretchable resistive sensor comprises only conducting particles which are provided directly on the surface of elongated elastic tube 110 in well-defined sections. A protective coating may be provided to protect the conductive particles. During application of the conducting particles on the elongated elastic tube 110, the conducting particles may have been provided in a solvent, which has been evaporated after application.

According to one embodiment the stretchable resistive sensor comprises conductive particles and a bearer material, for example and preferably an elastomer material. The bearer material preferably has liquid properties in which the conducting particles are suspended during the application of the stretchable resistive sensor on the elongated elastic tube 110 and cured to solid but stretchable state after the application. A number of suitable elastomer materials which also adheres well to the elongated elastic tube 110 are known to the skilled person. A suitable and commercially available elastomer is Ecoflex 00-30 from Smooth-on, sylgard 184 from Dow and elastosil 601 from Wacker Chemie.

An alternative to using conductive (solid) particles is utilizing liquid metal particle technology, also referred to as liquid metal droplet technology. According to one embodiment the stretchable resistive sensor comprises liquid metal particles, for example particles composed of liquid metal (gallium-indium-tin) and an elastomeric bearer.

The stretchable resistive sensor according to the described embodiments are provided directly on the surface elongated elastic tube 110 and in manners that make the stretchable resistive sensor become an integrated part of the elongated elastic tube 110. This is in contrast to sensors being provided as separate units glued on the tubing or provided in the sleeve, for example.

The stretchable resistive sensor according to the invention may also be utilized to measure temperature and other parameters that exhibit a dependence on the resistance changes of the stretchable resistive sensor. To differentiate resistance changes from temperature and strain, separate patterns in the elastomer may be used or calibration curves from controlled characterizations of each sensing are utilized. Electrical circuitry, for example, Wheatstone bridge, may be used to compensate temperature effect in strain sensing or vice versa by using reference temperature or strain sensors.

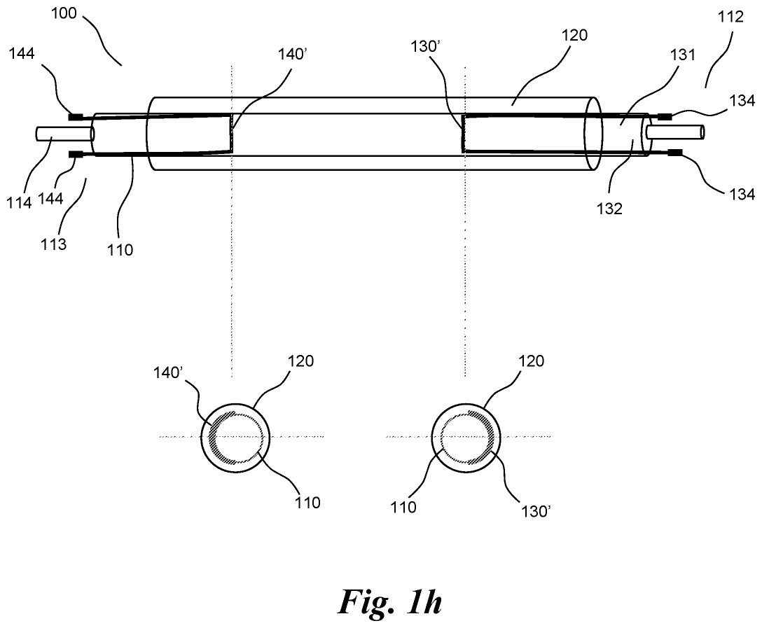

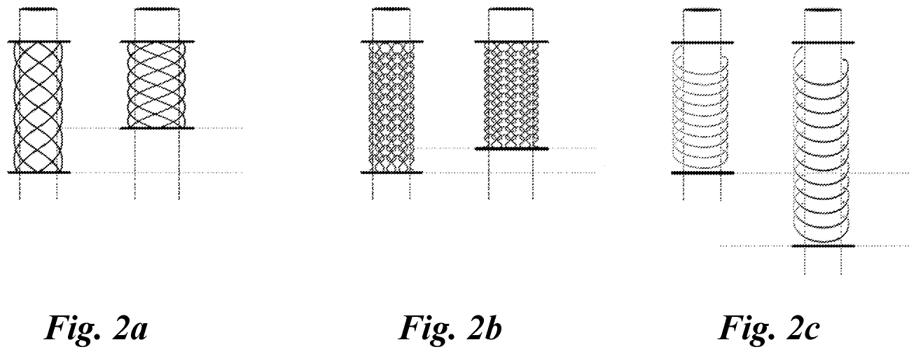

The interlocked sleeve 120 may be provided in various ways which are known in the art. FIG. 2a-c schematical illustrate three types of the interlocked sleeve 120 as non-limiting examples. FIG. 2a illustrates a braided sleeve, which is a well-known type of interlocked sleeve in its initial state (left drawing) and in an actuated state (right drawing). FIG. 2b illustrates a knitted sleeve in its initial state (left drawing) and in an actuated state (right drawing) and FIG. 2d illustrates a knitted coiled in its initial state (left drawing) and in an actuated state (right drawing). The actuation behavior is affected by several parameters of the sleeve such as the material, single strand length in the sleeve, braiding angle, diameter and expansion ratio. The basic actuation behavior may be illustrated with a braided sleeve according to FIG. 2a with which the working principle of the basic primitives is characterized by the relationship between the internal tubing and the braided outer mesh. When the outer braiding angles smaller than 54.4°, the fiber contracts, and when it is larger than 54.4°, it extends.

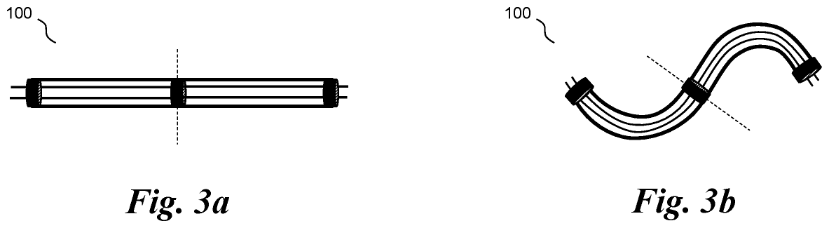

According to embodiments of the invention the interlocked sleeve 120 of the multilayered composite fluidic fiber actuator 100 has a varying configuration along the length of the multilayered composite fluidic fiber actuator 100, thereby providing varying morphing properties along the length of the multilayered composite fluidic fiber actuator 100. The varying configuration comprising a variation in one or a combination of: number of filaments, angles between the filaments, thickness of the filaments and additional mechanical constrains. The mechanical constraints may for example be an inlaid inelastic thread on the interlocked sleeve 120. A further alternative is flexible constraint placed on the actuator. By controlling the length, location, orientation, and number of mechanical constraint layers comprised in the multilayered composite fluidic fiber actuator 100 a variety of geometrical shapes and movements may be achieved. One example of an S-shape morphing state is schematically illustrated in FIGS. 3a-b wherein a) illustrates an initial state and the b) an actuated (pressurized) state. With the multilayered composite fluidic fiber actuator 100 according to the invention localized information about the strain in at least a first and a second portion in the longitudinal direction of the multilayered composite fluidic fiber actuator 100. Utilizing for example the embodiment described with reference to FIG. 1d or 1g, 2D information may be extracted from resistivity measurements of the at least four individual stretchable resistive sensors making it possible to detect and control for example the S-shape morphing state according to FIG. 3b.

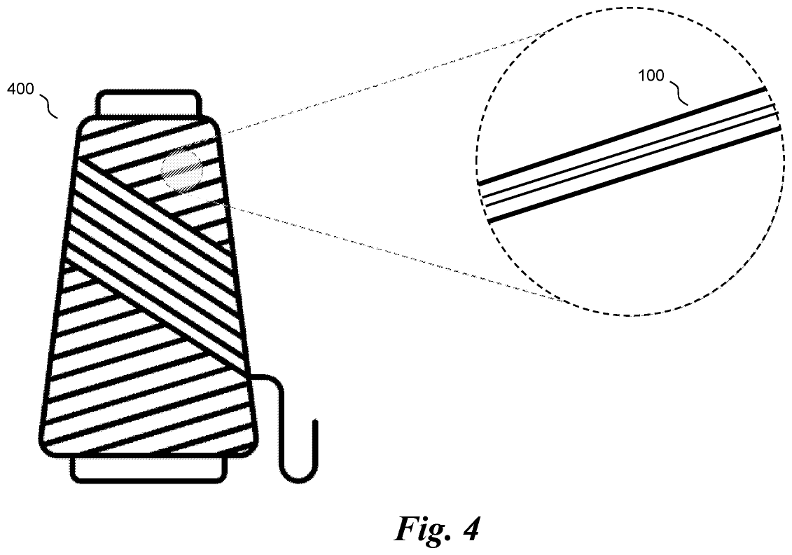

One of the advantages afforded by the multilayered composite fluidic fiber actuator 100 is that it may be fabricated in long lengths and due to its thinness and flexibility and that the stretchable resistive sensors are integrated with the elongated elastic tube can be handled like a yarn or textile Fibre. This is schematically illustrated in FIG. 4, showing a spool 400 of multilayered composite fluidic fiber actuator 100 with an enlarged section illustrating the details. The multilayered composite fluidic fiber actuator 100 may also be delivered as a coil or bobbin and may have lengths up to hundreds of meters.

According to aspects of the present invention the multilayered composite fluidic fiber actuator 100, and typically a plurality of such, are incorporated in a large variety of applications.

According to one embodiment of the invention an artificial muscle comprising a plurality of multilayered composite fluidic fiber actuators 100 is provided.

According to one embodiment of the invention a woven or knitted fabric being woven or comprising a plurality of multilayered composite fluidic fiber actuators 100 is provided. The fabric may be in one or a combination of the forms:
a 1D structure such as a yarn or sewn into the fabric as single strands; or 2-, 4-, 8-ply yarns
a 2D knitted structure such as a jersey knit, an interlock knit, a rib knit, a horizontal inlay, a vertical inlay, a diagonal inlay, a bourlette knit, a tubular knit, a pleated knit using wale direction, a pleated knit using course direction, intarsia, floating structures and fabric with protruding ridges;
a 2D woven structure such as a single-layer weave, twill weave, double woven, deflected double woven, or block weave structure;
a 3D structure such as a 3D knitted spacer fabric with active yarn spacers, a 3D knitted spacer fabric with active knitted walls, or multi-tube circular knitted fabrics.

The devices and fabrics described above may advantageously be part of a system also comprising modules for measuring resistance and controlling the pressure of the multilayered composite fluidic fiber actuators 100.

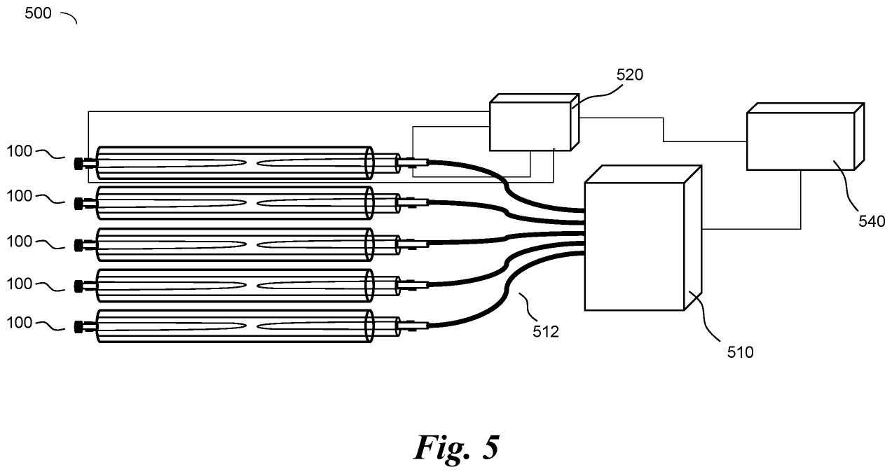

According to one aspect of the invention a fluidic actuator control and measurement system is provided. The fluidic actuator control and measurement system 500 according to the invention is schematically illustrated in FIG. 5 and comprises plurality of multilayered composite fluidic fiber actuators 100 according to what has been described with reference to FIGS. 1a-h. A pressure fluid source 510 is provided and is arranged to be in individual fluidic communication with the fluid connectors 114 of the multilayered composite fluidic fiber actuators 100 via tubing 512. Typically, and preferably, the pressure fluid source 510 has an individual fluid communication with each individual multilayered composite fluidic fiber actuators 100, but groupwise connection to sets of multilayered composite fluidic fiber actuators 100 could be envisaged. A sensor connection module 520 is provided and is arranged to be in individual electrical communication with each of the stretchable resistive sensors of the multilayered composite fluidic fiber actuators 100, which in the figure is indicated only for the uppermost multilayered composite fluidic fiber actuators 100, for reasons of not complicating the drawing. A control unit 540 is arranged to communicate with the pressure fluid source 510 and the sensor connection module 520, and wherein the control unit is arranged to receive resistance measurements, typically relating to the strain of the stretchable resistive sensor 130. The control unit 540 is further arranged to control the pressure fluid source 510 to apply fluid pressure to at least a portion of the individual multilayered composite fluidic fiber actuators 100. The control function may comprise both to which individual multilayered composite fluidic fiber actuators 100 to apply pressure and the actual pressure applied. The control unit 540 in combination with pressure fluid source 510 may further be arranged to provide a measure of a detected pressure in an individual multilayered composite fluidic fiber actuator 100 as an indication of the multilayered composite fluidic fiber actuators 100 being in a specific morphing state.

According to one embodiment the fluidic actuator control and measurement system 500 comprises, for each multilayered composite fluidic fiber actuators 100 at least four sensors in a pairwise configuration and the sensor connection module 520 is provided with a 4-channel input for each multilayered composite fluidic fiber actuators 100.

The fluidic actuator control and measurement system 500 according to the invention may be configured for geometric sensing, for example bending and coiling, as well as strain sensing, touch sensing and pressure sensing. In particular the fluidic actuator control and measurement system 500 according to the invention facilitates a Closed-loop Strain Control. In such known relationships between the actuator A length vs applied pressure, and actuator A length vs A resistance are utilized. From these relationships a mathematical mapping between the strain-induced resistance change and pressure can be established. When a user tangibly deforms (e.g. stretch) a device comprising multilayered composite fluidic fiber actuators 100, the strain sensors change their resistance, from which the deformed state may be computed. A mapping algorithm between strain and pressure is used to determine what pressures need to be supplied to the device comprising multilayered composite fluidic fiber actuators 100 to exhibit a similar deformation behaviour (e.g. elongation) and vice versa.

The small volume of the interior of elongated elastic tube 110 in combination with the flexibility of the multilayered composite fluidic fiber actuators 100 and the system components described above makes the fluidic actuator control and measurement system 500 particularly suitable for high frequency operations, wherein high frequencies in this context is above 10 Hz. In particular, the fluidic actuator control and measurement system 500 according to the invention may operate at frequencies up to 50 Hz, which correspond to a flow rate coefficient, Cv, of 0.016. Thereby the fluidic actuator control and measurement system 500 can provide a vibrational sensing system and/or vibrational system for applying vibrations to a user.

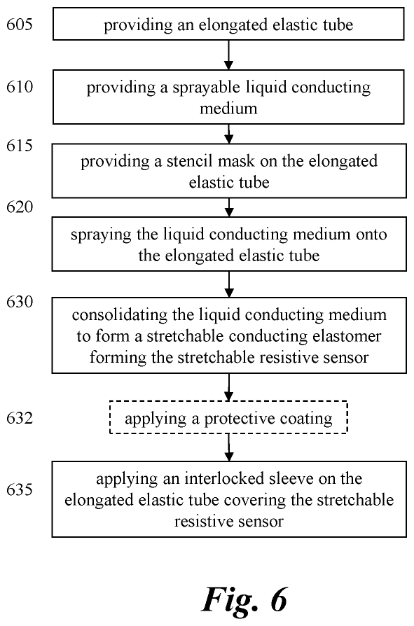

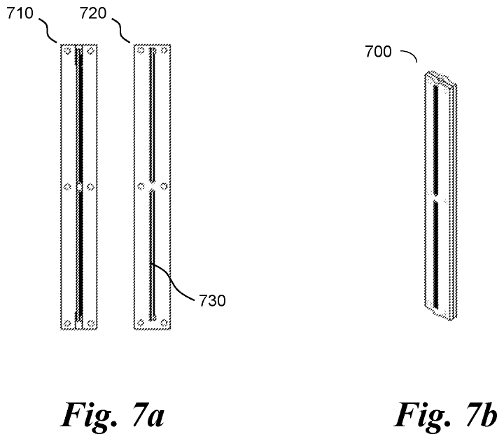

As described above the stretchable resistive sensors are provided as deposited structures on the elongated elastic tube 110 so that the stretchable resistive sensors are integrated with the elongated elastic tube 110. Several suitable methods exist for providing the stretchable resistive sensors. According to one aspect of the invention a method is provided based on spraying. The method is described with reference to the flowchart of FIG. 6 and the schematic illustrations of FIG. 7a-b.

The method comprises the steps of:
605: —providing an elongated elastic tube 110;
610: —providing a sprayable liquid conducting medium;
615: —providing a stencil mask on the elongated elastic tube 110, the mask provided with at least one elongated opening, the elongated opening defining the stretchable resistive sensor 130;
620: —spraying the liquid conducting medium onto the elongated elastic tube 110 partly covered by the stencil mask;
625: —removing the stencil mask;
630: —consolidating the liquid conducting medium to form a stretchable conducting elastomer forming the stretchable resistive sensor 130; and
635: —applying an interlocked sleeve 120 on the elongated elastic tube 110 covering the stretchable resistive sensor 130.

The method may also comprise a step 632 to be taken before the step of applying an interlocked sleeve 635 of applying a protective coating at least on top of the formed stretchable resistive sensor 130. The protecting may for example be applied by spraying or dipping and is typical of a polymer material.

The liquid conducting medium that may be sprayed and which are suitable for the above described embodiments of the stretchable resistive sensor, includes but is not limited to: carbon-based particles in solvent, carbon particles and elastomer in solvent, liquid metal particles, liquid metal in solvent. The carbon powder may be carbon black comprising nanoparticles.

The consolidating step 625 may include drying or evaporating a solvent if such is present in the liquid conducting medium. If the liquid conducting medium comprises an elastomer material, the consolidating step 625 may include curing the material, for example with UV-light or by raising the temperature.

A stencil mask 700 suitable for the method is schematically illustrated in FIGS. 7a-b. According to this embodiment the stencil mask 700 comprises two stencil mask halves 710, 720 with a longitudinal depression arranged to accommodate the elongated elastic tube (not shown). During use the two stencil mask halves 710, 720 are pressed together to enclose the elongated elastic tube. At least one of the two stencil mask halves 710, 720 is provided with an opening 730 that will define a corresponding stretchable resistive sensor. Typically, the opening is tapered so that closest to the opening the thickness of the stencil is as small as possible given that its mechanical stability must be preserved. The tapering helps ensures a well-defined result of the spraying. Suitable materials for the stencil mask are stainless steels and polymers for example high density polyethylene. The mask may for example be fabricated by 3D-printing, laser cutting, milling, or lithographic etching.

Spraying methods include spraying with different types of nozzles that can spray carbon black solutions, carbon black and elastomer solutions, and liquid metal particles. Airbrushes may be used to spray those materials with 5˜50 psi pressure ranges to fabricate the stretchable resistive sensor on elastomer surfaces.

The embodiments described above are to be understood as illustrative examples of the system and method of the present invention. It will be understood that those skilled in the art that various modifications, combinations and changes may be made to the embodiments. In particular, different part solutions in the different embodiments can be combined in other configurations, where technically possible.

1. A multilayered composite fluidic fiber actuator arranged to have at least a first and a second morphing state dependent on the pressure of an internal fluid, the multilayered composite fluidic fiber actuator comprising:
an elongated elastic tube with a hollow body, the hollow body arranged to accommodate the internal fluid, the elongated elastic tube having a first end and a second end and at least at one of the first and a second end is provided with a fluid connector;
an interlocked sleeve enclosing the elongated elastic tube and extending a major portion of the elongated elastic tube in the longitudinal direction;
a first stretchable resistive sensor provided on the outer surface of and integrated with the elongated elastic tube and enclosed by the interlocked sleeve and extending a first distance on the elongated elastic tube, the first stretchable resistive sensor comprising connecting means; and
at least a second stretchable resistive sensor provided on the outer surface of and integrated with the elongated elastic tube and enclosed by the interlocked sleeve and extending a second distance on the elongated elastic tube, the second stretchable resistive sensor comprising connecting means,
wherein the second stretchable resistive sensor is electrically separated from the first stretchable resistive sensor, and
wherein at least a first portion in the longitudinal direction of the elongated elastic tube has a first configuration and a second portion in the longitudinal direction of the elongated elastic tube has a second and different configuration of the first stretchable resistive sensor and the second stretchable resistive sensor.

2. The multilayered composite fluidic fiber actuator according to claim 1, wherein the first stretchable resistive sensor is elongated and extends a first distance in the longitudinal direction of the elongated elastic tube and thereby arranged to register the strain in the longitudinal direction,
wherein the second stretchable resistive sensor is elongated and extends a second distance in the longitudinal direction of the elongated elastic tube and thereby arranged to register the strain in the longitudinal direction, and
wherein the first and second stretchable resistive sensors are arranged so that for a portion in the longitudinal direction of the elongated elastic tube only one of the first and second stretchable resistive sensors is present.

3. The multilayered composite fluidic fiber actuator according to claim 2, wherein the first stretchable resistive sensor extends a first portion in the longitudinal direction of the elongated elastic tube and the second stretchable resistive sensor extends a second portion in the longitudinal direction of the elongated elastic tube and the wherein the first portion and the second portion are separated and sequential in the longitudinal direction of the elongated elastic tube.

4. The multilayered composite fluidic fiber actuator according to claim 2, further comprising:
a third stretchable resistive sensor provided on the outer surface of and integrated with the elongated elastic tube and enclosed by the interlocked sleeve and extending a third distance in the longitudinal direction of the elongated elastic tube, the third stretchable resistive sensor comprising connecting means, the third stretchable resistive sensor at least partly overlapping in the longitudinal direction with the first stretchable resistive sensor and wherein the first stretchable resistive sensor is provided on a first half and the third stretchable resistive sensor is provided on the opposite half of the elongated elastic tube in a cross-sectional view of the elongated elastic tube, the first stretchable resistive sensor and the third stretchable resistive sensor forming a first sensor pair; and
a fourth stretchable resistive sensor provided on the outer surface of and integrated with the elongated elastic tube and enclosed by the interlocked sleeve and extending a fourth distance in the longitudinal direction of the elongated elastic tube, the fourth stretchable resistive sensor comprising connecting means, the fourth stretchable resistive sensor at least partly overlapping in the longitudinal direction with the second stretchable resistive sensor and wherein the second stretchable resistive sensor is provided on a third half and the fourth stretchable resistive sensor is provided on the opposite half of the elongated elastic tube in a cross-sectional view of the elongated elastic tube, the second stretchable resistive sensor and the fourth stretchable resistive sensor forming a second sensor pair.

5. The multilayered composite fluidic fiber actuator according to claim 4, wherein the first stretchable resistive sensor and the third stretchable resistive sensor are arranged essentially opposite each other in the cross-sectional view of the elongated elastic tube and/or the second stretchable resistive sensor and the fourth stretchable resistive sensor are arranged essentially opposite each other in the cross sectional view of the elongated elastic tube.

6. The multilayered composite fluidic fiber actuator according to claim 4, wherein the first stretchable resistive sensor and the second stretchable resistive sensor are positioned sequentially in the longitudinal direction of the elongated elastic tube and having the same circumferential position in the cross sectional view of the elongated elastic tube; and/or the third stretchable resistive sensor and the fourth stretchable resistive sensor are positioned sequentially in the longitudinal direction of the elongated elastic tube and having the same circumferential position in the cross sectional view of the elongated elastic tube.

7. The multilayered composite fluidic fiber actuator according to claim 1, wherein at least three stretchable resistive sensor are provided in the first longitudinal portion of the elongated elastic tube, evenly distributed on the circumference of the elongated elastic tube, and
wherein at least three stretchable resistive sensor are provided in the second longitudinal portion of the elongated elastic tube evenly distributed on the circumference of the elongated elastic tube, thereby providing a capability of 3D information of the motion and/or morphing state of the multilayered composite fluidic fiber actuator.

8. The multilayered composite fluidic fiber actuator according to claim 1, wherein at least one of the stretchable resistive sensor comprises a first thin sensor leg extending in the longitudinal direction of the elongated elastic tube, and a thin second leg extending in the same longitudinal direction of the elongated elastic tube, and wherein the first and second leg are electrically joined at their distal ends.

9. The multilayered composite fluidic fiber actuator according to claim 8, wherein at least one of the stretchable resistive sensors is arranged as a continuous thin structure and the first and second legs are joined by a U-shaped portion at their distal end.

10. The multilayered composite fluidic fiber actuator according to claim 4, wherein the first stretchable resistive sensor comprises a first thin sensor leg extending from the first end towards the second end of the elongated elastic tube, and a thin second leg extending from the first end towards the second end of the elongated elastic tube and wherein the first and second leg are electrically joined at their distal ends,
wherein the third stretchable resistive sensor comprises a first thin sensor leg extending from the first end towards the second end of the elongated elastic tube, and a thin second leg extending from the first end towards the second end of the elongated elastic tube and wherein the first and second leg are electrically joined at their distal ends,
wherein the second stretchable resistive sensor comprises a first thin sensor leg extending from the second end towards the first end of the elongated elastic tube, and a thin second leg extending from the second end towards the first end of the elongated elastic tube and wherein the first and second leg are electrically joined at their distal ends, and
wherein the fourth stretchable resistive sensor comprises a first thin sensor leg extending from the second end towards the first end of the elongated elastic tube, and a thin second leg extending from the second end towards the first end of the elongated elastic tube and wherein the first and second leg are electrically joined at their distal ends.

11. The multilayered composite fluidic fiber actuator according to claim 10, wherein at least one of the stretchable resistive sensors is arranged as a continuous thin structure and the first and second legs are joined by a U-shaped portion at their distal end.

12. The multilayered composite fluidic fiber actuator according to claim 6, wherein at least one of the first stretchable resistive sensor and the second stretchable resistive sensor is spiraled around the elongated elastic tube.

13. The multilayered composite fluidic fiber actuator according to claim 1, wherein the first stretchable resistive sensor extends a first distance primarily in the transversal direction of the elongated elastic tube and thereby arranged to register strain relating to a radial expansion of the elongated elastic tube at the first portion of the elongated elastic tube,
wherein the second stretchable resistive sensor extends a second distance primarily in the transversal direction of the elongated elastic tube and thereby arranged to register strain relating to a radial expansion of the elongated elastic tube at the second portion of the elongated elastic tube, and
wherein the first and second stretchable resistive sensors are provided in separate longitudinal portions of the elongated elastic tube.

14. The multilayered composite fluidic fiber actuator according to claim 1, wherein the stretchable resistive sensor is formed from a material comprising electrically conducting particles.

15. The multilayered composite fluidic fiber actuator according to claim 14, wherein the stretchable resistive sensor is formed from an elastomer material comprising electrically conducting nanoparticles.

16. The multilayered composite fluidic fiber actuator according to claim 14, wherein the conducting elastomer material comprises carbon black.

17. The multilayered composite fluidic fiber actuator according to claim 1, wherein the stretchable resistive sensor is formed from a material comprising liquid metal particles.

18. The multilayered composite fluidic fiber actuator according to claim 1, wherein the stretchable resistive sensor is deposited structures on the elongated elastic tube.

19. The multilayered composite fluidic fiber actuator according to claim 1, wherein the elongated elastic tube has an average diameter in its non-pressurized state that is less than 3 mm, and each individual stretchable resistive sensor extends in the range 0.1-2 mm in the circumferential direction.

20. The multilayered composite fluidic fiber actuator according to claim 1, wherein the interlocked sleeve has a varying configuration along the length of the multilayered composite fluidic fiber actuator, thereby providing varying morphing properties along the length of the multilayered composite fluidic fiber actuator, the varying configuration comprising a variation in one or a combination of: number of filaments, angles between the filaments, thickness of the filaments, and added constrains.

21. A fluidic actuator control and measurement system, comprising:
a plurality of multilayered composite fluidic fiber actuators according to claim a pressure fluid source arranged to be in individual fluidic communication with the fluid connectors of the multilayered composite fluidic fiber actuators;
a sensor connection module arranged to be in individual electrical communication with the sensors of the multilayered composite fluidic fiber actuators; and
a control unit arranged to communicate with the pump module and the sensor connection module,
wherein the control unit is arranged to receive resistive data for at least a portion of the individual sensors of the individual multilayered composite fluidic fiber actuators and to control the pump module to apply fluid pressure to at least a portion of the individual multilayered composite fluidic fiber actuators.

22. The fluidic actuator control and measurement system according to claim 21, wherein each multilayered composite fluidic fiber actuators comprises at least four sensors in a pairwise configuration and the sensor connection module is provided with a 4-channel input for each multilayered composite fluidic fiber actuators.

23. The fluidic actuator control and measurement system according to claim 21, wherein the fluidic actuator control and measurement system is arranged to operate at frequencies up to 40 Hz.

24. An artificial muscle comprising a plurality of multilayered composite fluidic fiber actuators according to claim 1.

25. A fabric being woven or knitted, comprising a plurality of multilayered composite fluidic fiber actuators according to claim 1.

26. The fabric according to claim 25, wherein the multilayered composite fluidic fiber actuators are provided in the fabric in one or a combination of the forms:
a 1D structure such as a yarn or sewn into the fabric as single strands; or 2-ply yarns,
a 2D knitted structure such as a plain knit, a rib knit, a horizontal inlay, a vertical inlay, a diagonal inlay, bourlette knit, tubular knit, pleated knit using wale direction, pleated knit using course direction, intarsia, floating structures and fabric with protruding ridges,
a 2D woven structure such as a single-layer weave, and
a 3D structure such as a 3D knitted spacer fabric with active yarn spacers, a 3D knitted spacer fabric with active knitted walls, multi-tube circular knitted fabrics.

27. A method of producing a multilayered composite fluidic fiber actuator, the resulting multilayered composite fluidic fiber actuator comprising an elongated elastic tube with a hollow body, an interlocked sleeve enclosing the elongated elastic tube and extending a major portion of the elongated elastic tube in the longitudinal direction and at least one stretchable resistive sensor, the method comprising the steps of:
providing an elongated elastic tube;
providing a sprayable liquid conducting medium;
providing a stencil mask on the elongated elastic tube, the mask provided with at least one elongated opening, the elongated opening defining the stretchable resistive sensor;
spraying the liquid conducting medium onto the elongated elastic tube partly covered by the stencil mask;
removing the stencil mask;
consolidating the liquid conducting medium to form a stretchable conducting elastomer forming the stretchable resistive sensor; and
applying an interlocked sleeve on the elongated elastic tube covering the stretchable resistive sensor.

28. The method according to claim 27, further comprising a step of applying a protective layer onto the elongated elastic tube and the stretchable resistive sensor prior to the step of applying the interlocked sleeve.

29. The method according to claim 27, wherein the liquid conducting medium is selected from the list: carbon-based powders in solvent, carbon powders and elastomer in solvent, liquid metals, and liquid metal in solvent.

30. The method according to claim 27, wherein the consolidating step includes curing the sprayed liquid conducting medium.
